(19) United States
(12) Patent Application Publication
(10) Pub. No.: US 2010/0272295 A1
(43) Pub. Date: Oct. 28, 2010

(54) SPEAKER DEVICE HAVING DIRECTIVITY ADJUSTMENT PANEL

(76) Inventor: Eiji Nakatani, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/747,274

(22) PCT Filed: Dec. 15, 2008
(86) PCT No.: PCT/JP2008/003761

§ 371 Date: Jun. 10, 2010

(30) Foreign Application Priority Data
Dec. 18, 2007 (JP) 2007-325556

(51) Int. Cl. H04R 1/34

(52) U.S. Cl. 381/160

(57) ABSTRACT

The invention provides a speaker device having wide directivity and exhibiting excellent frequency characteristics with a simple configuration, and to this end, a directivity adjustment panel is arranged to cover one part of a vibration region of a vibration plate of a speaker unit, the directivity adjustment panel being arranged with a predetermined distance from an edge portion of an outer periphery of the vibration plate of the speaker unit, and formed to reflect a sound wave received from the vibration plate toward the vibration plate.

### TECHNICAL FIELD

The present invention relates to a speaker device having a directivity adjustment panel for adjusting a directivity of a sound.

### BACKGROUND ART

A speaker device including a full-range speaker unit is known for a speaker device designed to cover a sound range of about 20 Hz to 20 kHz, which is an audible range of a human, as much as possible. Such a full-range speaker unit is configured to cover each sound range, a low sound range and a high range with a mid-sound range as a center, with one speaker unit. The full-range speaker unit excels in auditory lateralization since one sound source exists, and has a merit in that it can be manufactured at low cost.

However, as it is difficult to cover all sound ranges with one speaker unit, there are provided various types of speaker devices configured to cover the sound range as wide as possible by combining a plurality of speaker units. In the speaker device in which the plurality of speaker units are combined, sound quality, auditory lateralization, clarity of an audio image and the like need to be enhanced by matching a directivity, a phase, a radiation axis (center axis), and the like of each speaker unit. One of the speaker devices that satisfy such conditions is a coaxial speaker device or a virtual coaxial speaker device.

The coaxial-type speaker device in which a tweeter is fixed to a center pole of a main speaker unit is known for the coaxial speaker device, where the radiation axis of each speaker unit is coaxially arranged. Such a coaxial speaker device is used as a car audio, and the like. Sound quality and miniaturization are prioritized in the car audio to enhance the spatial efficiency in a vehicle. For example, a coaxial speaker device disclosed in Japanese Unexamined Patent Publication No. 2002-209293 is configured to arrange a diagonal reflection plate on the front side of the tweeter to control the directivity so that the radiation axis is directed in a direction of a listener. Thus, as the position of the listener with respect to the speaker device is specified in a narrow compartment in the car audio, the reflection plate is arranged to direct the radiation axis in the direction of the listener, and in particular, to control the directivity of the sound wave of the high sound range.

The virtual coaxial speaker device is configured such that one high sound range speaker unit (tweeter) is sandwiched by two mid-low sound range speaker units (woofers), and a virtual radiation axis of a composite sound of the two woofers is arranged on the radiation axis of the tweeter. According to such a configuration, the diameter of the virtual woofer configured by two woofers can be set large, and the auditory lateralization characteristics of the same extent as the woofer of large diameter can be obtained by arranging two woofers having a small diameter. In the present specification, the high sound range refers to the frequency band of higher than or equal to about 8 kHz, the mid-sound range refers to the frequency band in the range of between 1 kHz and 8 kHz, and the low sound range refers to the frequency band of lower than or equal to 1 kHz.

Patent Literature 1: Japanese Unexamined Patent Publication No. 2002-209293

### DISCLOSURE OF THE INVENTION

### Problems to be Solved by the Invention

Since a full-range speaker unit is a cone-shaped speaker, the directivity of the speaker unit is dominated by an effective vibration radius of a vibration plate, and a practical limit frequency at which the directivity degrades is determined by the effective vibration radius. Furthermore, with regards to directivity sensitivity characteristics that is frequency characteristics at an angle deviated from the radiation axis that is the reference axis of the speaker unit, the directivity becomes worse the more deviated from the radiation axis, and in particular, attenuation becomes larger for the frequency of high sound range.

In a cone-shaped speaker unit, entire cone paper that is the vibration plate reciprocates and vibrates up to a low frequency such as a frequency of about 1 kHz, but divided vibration occurs on the cone paper from just beyond such a low frequency. In other words, a plurality of vibration regions generates on the entire surface of the cone paper. If a listener listens to the sound of the speaker unit in which such a divided vibration occurred at a position deviated from the radiation axis that is the center axis of the speaker unit, the listener will also listen to the sound from a plurality of vibration regions generated at distant positions on the outer peripheral portion of the cone paper. In this case, if sounds shifted by half-wavelength in the sound from the plurality of vibration regions generated at the outer peripheral portion of the cone paper reach the listener, such sounds cancel each other out, and a sound pressure level thereof greatly attenuates. Thus, the listener listening at the position deviated from the radiation axis of the speaker unit listens to a sound different from the listener listening on the radiation axis of the speaker unit. The frequency at which such a phenomenon occurs differs depending on the diameter of the speaker unit and the position where the listener is listening, but if such a phenomenon appears in a mid-sound range, in particular, the sound may lack the mid-sound range and the listener may feel a sense of discomfort.

As described above, since the coaxial speaker device and the virtual coaxial speaker device are configured by a plurality of speaker units, the sound range of each speaker unit needs to be smoothly connected at the crossover frequency where they intersect. In particular, the sound range of each speaker unit is preferably smoothly connected at a crossover frequency where they intersect even in a case where the listener is listening at a position shifted from the virtual radiation axis of the virtual coaxial speaker device. For example, in the case of the virtual coaxial speaker device in which a sound range of a mid-high sound range speaker (tweeter) is higher than or equal to about 4 kHz, and a sound range of a mid-low sound range speaker (woofer) is lower than or equal to about 4 kHz, the crossover frequency where the sound ranges of the mid-high sound range speaker and the mid-low sound range speaker intersect is about 4 kHz.

In the cone-shaped speaker unit, the divided vibration occurs in the mid-sound range, and a phenomenon in which the sound pressure level of the mid-sound range rapidly attenuates occurs, as described above. Problems arise in the virtual coaxial speaker device configured as above since the tweeter is in charge of the mid-high sound range (higher than or equal to 4 kHz), and the woofer that is the cone-shaped speaker unit is in charge of the mid-low sound range (lower than or equal to 4 kHz). In other words, in the virtual coaxial speaker device configured such that the tweeter is sandwiched by two woofers, attenuation occurs at the sound pressure level of the mid-sound range (e.g., between 1 and 4 kHz), which the tweeter is not in charge.

Therefore, in order to solve such problems, consideration is made in the coaxial speaker device and the virtual coaxial speaker device to have the woofer that is the cone-shaped speaker in charge of the low sound range and the tweeter that is the dome-shaped speaker in charge of the mid-high sound range. However, if the speaker device is configured such that the tweeter is in charge of the mid-high sound range, the high quality of the speaker device is realized but a manufacturing cost becomes high, and hence such a speaker device cannot be incorporated in general audio equipment of low manufacturing cost that is sold at low price.

The problems in the configuration of the virtual coaxial speaker device incorporated in a conventional audio device will be described below.

The virtual coaxial speaker device has superiority in auditory lateralization since an audio image is close to a point sound source, similar to the coaxial speaker device in which the radiation axes of a plurality of speaker units are coaxially arranged. Thus, the auditory lateralization characteristics of the same extent as the woofer having a large diameter can be exhibited using a plurality of woofers having a small diameter, and a width dimension of a cabinet can be greatly reduced from the coaxial speaker that uses the woofer having a large diameter.

FIG. 20 is a perspective view showing a conventional virtual coaxial speaker device. FIG. 21 is a view showing a positional relationship of the conventional virtual coaxial speaker device and a listener. In FIG. 21, the conventional virtual coaxial speaker device is shown in a side cross-sectional view.

In the virtual coaxial speaker device shown in FIG. 20, woofers 102, 103 are arranged in a line in a vertical direction on both sides of a tweeter 104. The woofers 102, 103 are speaker units that reproduce an audio signal of mid-low sound range. The tweeter 104 is a speaker unit that reproduces an audio signal of high sound range. A speaker box 101 is a cabinet including the woofers 102, 103, and the tweeter 104.

A radiation axis X shown in FIG. 21 is a center axis passing the center of the tweeter 104. The woofers 102, 103 are speaker units having the same characteristics. When the same audio signal is simultaneously inputted to both woofers 102, 103, the same audio is generated at both woofers 102, 103, and a virtual radiation axis of a composite sound thereof is at the same position as a radiation axis X of the tweeter 104. Therefore, if an ear of a listener 8 is on the axis of the radiation axis X passing the center of the tweeter 104, a difference is not created in the distance in the sound that reaches the listener 8 from the two woofers 102, 103, and the sounds from the two woofers 102, 103 all reach the ear of the listener 8 at the same phase.

However, in the conventional virtual coaxial speaker device, the two woofers 102, 103 are normally arranged with the tweeter 104 therebetween in the longitudinal direction of the speaker box 101 (up and down direction in FIG. 22), and thus an effective diameter in the longitudinal direction in which the two woofers 102, 103 are lined becomes large. As a result, the conventional virtual coaxial speaker device has a problem in that the directivity of the mid-high sound range degrades in the longitudinal direction. The reasons therefor will be described below. As shown in FIG. 22, when the listener 8 listens to the sound at the position deviated from the radiation axis X, a distance difference L is created between a distance from the upper part of the vibration plate of the upper woofer 102 to the listener 8 and a distance from the lower part of the vibration of the lower woofer 103 to the listener 8.

FIG. 23 is an image view of a sound wave radiated from the two woofers 102, 103 of the virtual coaxial speaker device, and shows a case where the respective sound waves are shifted by half-wavelength. In FIG. 23, a broken line is the image waveform of the sound wave radiated from one woofer 102, and a solid line is the image waveform of the sound wave radiated from the other woofer 103. The sound wave is originally a longitudinal wave, but is drawn as a transverse wave in FIG. 23 to facilitate the understanding. For example, if the distance difference L between the distance from the upper part of the vibration plate of the upper woofer 102 to the listener 8 and the distance from the lower part of the vibration plate of the lower woofer 103 to the listener 8 is the frequency corresponding to the half-wavelength, as shown in FIG. 23, the sound waves cancel each other out, and an attenuated sound reaches the listener 8 with respect to such a frequency. Thus, the greater the distance difference L from each woofer 102, 103 to the listener 8 is, the half-wavelength of the sound waves that cancel out becomes longer and the frequency becomes lower. Thus, attenuation occurs from the mid-sound range if the distance difference L is large, whereby the frequency characteristics around the mid-sound range band degrade and the directivity at the relevant position also degrades.

One method of solving the above problems includes using a tweeter having a wide frequency band capable of reproducing higher than or equal to 1 kHz in the virtual coaxial speaker device. However, if the tweeter having such a wide frequency band is used as described above, the price of the speaker device becomes high, and such a speaker device cannot be used in an audio device sold at low price.

Therefore, a speaker device having excellent frequency characteristics even in the mid-sound range without using an expensive tweeter, and exhibiting a wide directivity enabling a high quality sound to be heard even at the position deviated from the radiation axis is desired not only in the virtual coaxial speaker device, but also in the coaxial speaker device.

It is an object of the present invention to provide a high quality speaker device of low cost having a simple configuration and a wide directivity.

### Means for Solving the Problems

A speaker device according to a first aspect of the present invention includes:

a speaker unit including a vibration plate that becomes a sound source;

a cabinet attached with the speaker unit; and

a directivity adjustment panel arranged with a predetermined distance from an edge portion of an outer periphery of the vibration plate of the speaker unit to cover one portion in a vibration region of the vibration plate of the speaker unit; wherein

the directivity adjustment panel is configured to reflect a sound wave received from the vibration plate toward the vibration plate. The speaker device of the first aspect configured in such a manner provides an acoustic device having wide directivity and exhibiting excellent frequency characteristics with a simple configuration and at low cost.

According to a second aspect of the present invention, there is provided the speaker device according to first aspect, wherein the directivity adjustment panel includes a reflection surface parallel to a plane configured by the edge portion of the outer periphery of the vibration plate, the reflection surface including a shielding portion arranged to face the vibration plate and a supporting portion for fixing the shielding portion to the cabinet. The speaker device of the second aspect configured in such a manner has excellent frequency characteristics and wide directivity.

According to a third aspect of the present invention, there is provided the speaker device according to the first aspect, wherein the directivity adjustment panel includes a reflection surface in which a position facing a center side of the vibration plate is arranged closer to the vibration plate than a position facing the edge portion side, the reflection surface including a shielding portion arranged to face the vibration plate and a supporting portion for fixing the shielding portion to the cabinet. The speaker device of the third aspect configured in such a manner has wide directivity and exhibits excellent frequency characteristics.

According to a fourth aspect of the present invention, there is provided the speaker device according to the second and third aspects, wherein the shielding portion may have a fan shape in which a portion facing the edge portion of the vibration plate is formed large and a portion facing the center side of the vibration plate is formed small.

According to a fifth aspect of the present invention, there is provided the speaker device according to the second and third aspects, wherein the shielding portion preferably has a fan shape in which a portion facing the edge portion of the vibration plate is large and a portion facing the center side of the vibration plate is a vertex, a vertex angle of the fan shape being within a range of between 60 degrees and 120 degrees.

According to a sixth aspect of the present invention, there is provided the speaker device according to the second and third aspects, wherein the shielding portion is arranged to cover upper and lower portions of the vibration region of the vibration plate. The speaker device of the sixth aspect configured in such a manner exhibits excellent frequency characteristics without a specific sound range attenuating even when listened at a position deviated from a radiation axis.

According to a seventh aspect of the present invention, the speaker device according to the second and third aspects is a virtual coaxial speaker device in which the speaker unit is configured by sandwiching one tweeter with two woofers, the directivity adjustment panel being arranged on the two woofers. The speaker device of the seventh aspect configured in such a manner is a virtual coaxial speaker device having wide directivity that exhibits excellent frequency characteristics without a specific sound range attenuating even when listened at a position deviated from a radiation axis.

According to an eighth aspect of the present invention, the speaker device according to the second and third aspects is a coaxial speaker device in which the speaker unit has a tweeter and a woofer coaxially arranged, the directivity adjustment panel being arranged on the woofer. The speaker device of the eighth aspect configured in such a manner is a coaxial speaker device having wide directivity that exhibits excellent frequency characteristics without a specific sound range attenuating even when listened at a position deviated from a radiation axis.

According to a ninth aspect of the present invention, the speaker device according to the second and third aspects is a speaker device in which the speaker unit is a full range speaker unit, the shielding portion being arranged to cover upper and lower portions of the vibration region of the vibration plate. The speaker device of the ninth aspect configured in such a manner is an acoustic device having wide directivity that exhibits excellent frequency characteristics without a specific sound range attenuating even when listened at a position deviated from a radiation axis.

According to a tenth aspect of the present invention, there is provided the speaker device according to the second and third aspects, wherein the directivity adjustment panel may be integrally molded with the cabinet.

According to an eleventh aspect of the present invention, there is provided the speaker device according to the second and third aspects, wherein the directivity adjustment panel may be configured to be removably attachable with respect to the cabinet.

A virtual coaxial speaker device according to a twelfth aspect of the present invention in which two woofers are installed on a baffle plate of a cabinet, wherein

a directivity adjustment panel is arranged to cover one part of each of the two woofers; and

the directivity adjustment panel is formed facing an edge portion on both sides spaced apart from a virtual radiation axis of a vibration plate of the two woofers, and is configured so that a shielding region becomes smaller from an edge portion towards a center portion to cover one part of the woofer. The speaker device of the twelfth aspect configured in such a manner has wide directivity and exhibits excellent frequency characteristics with a simple configuration and at low cost.

According to a thirteenth aspect of the present invention, there is provided the speaker device according to the twelfth aspect, wherein the directivity adjustment panel may be integrally formed with the cabinet.

According to a fourteenth aspect of the present invention, there is provided the speaker device according to the twelfth and thirteenth aspects, wherein the directivity adjustment panel is arranged with a predetermined distance from the edge portion of the vibration plate of the woofer. The speaker device of the thirteenth aspect configured in such a manner attenuates a specific region of the sound wave from the vibration region of the vibration plate, has wide directivity, and exhibits excellent frequency characteristics.

Novel features of the invention are particularly described in the appended claims, but the invention, together with other objects and features thereof, may best be understood and evaluated by reading the detailed description below together with the accompanying drawings with regards to both the configuration and the content.

### Effects of the Invention

The speaker device of the present invention provides a high quality speaker device at low cost since a directivity adjustment panel of a simple configuration is arranged to cover one part of the vibration region of the vibration plate so as to have wide directivity and exhibit excellent frequency characteristics.

### BRIEF DESCRIPTION OF THE DRAWINGS

FIG. 1 is a perspective view showing a virtual coaxial speaker device according to a first embodiment of the present invention.

FIG. 2 is an explanatory view showing a relationship of the virtual coaxial speaker device of the first embodiment and a listener.

FIG. 3 is a cross-sectional view showing a front baffle unit in the virtual coaxial speaker device of the first embodiment.

FIG. 4 is a view showing frequency characteristics in a virtual coaxial speaker device having a conventional configuration.

FIG. 5 is a view showing frequency characteristics in the virtual coaxial speaker device of the first embodiment.

FIG. 6 is a view showing the frequency characteristics in a case where a directivity adjustment panel is arranged at a distance 0 mm from the front baffle unit in the virtual coaxial speaker device of the first embodiment.

FIG. 7 is a view showing the frequency characteristics in a case where the directivity adjustment panel is arranged at a distance 2.5 mm from the front baffle unit in the virtual coaxial speaker device of the first embodiment.

FIG. 8 is a view showing the frequency characteristics in a case where the directivity adjustment panel is arranged at a distance 8.5 mm from the front baffle unit in the virtual coaxial speaker device of the first embodiment.

FIG. 9 is a view showing the frequency characteristics in a case where the directivity adjustment panel is arranged at a distance 11.5 mm from the front baffle unit in the virtual coaxial speaker device of the first embodiment.

FIG. 10A is a view showing the frequency characteristics of only a woofer when the directivity adjustment panel is not arranged in the virtual coaxial speaker device of the conventional configuration.

FIG. 10B is a view showing the frequency characteristics of only the woofer when the directivity adjustment panel is arranged in the virtual coaxial speaker device of the first embodiment.

FIG. 11 is a view showing the frequency characteristics diagram of only a tweeter when the directivity adjustment panel is arranged in the virtual coaxial speaker device of the first embodiment.

FIG. 12 is a perspective view of a case where the directivity adjustment panel has a semicircular shape in the virtual coaxial speaker device according to the first embodiment of the present invention.

FIG. 13 is a view showing the frequency characteristics of the virtual coaxial speaker device shown in FIG. 12.

FIG. 14 is a perspective view of a case where the directivity adjustment panel has a rectangular shape in the virtual coaxial speaker device according to the first embodiment of the present invention.

FIG. 15 is a view showing the frequency characteristics of the virtual coaxial speaker device shown in FIG. 14.

FIG. 16 is a perspective view showing a virtual coaxial speaker device in which the directivity adjustment panels are formed as separate bodies from a speaker box in a speaker device according to the present invention.

FIG. 17 is a perspective view showing a speaker device including a full range speaker according to a second embodiment of the present invention.

FIG. 18 is a cross-sectional view showing a front baffle unit in the speaker device of the second embodiment.

FIG. 19 is a front view showing a coaxial speaker device according to a third embodiment of the present invention.

FIG. 20 is a perspective view showing a conventional virtual coaxial speaker device.

FIG. 21 is a view showing a relationship of the conventional virtual coaxial speaker device and a listener.

FIG. 22 is an explanatory view of a case where the listener is at a position distant from a center axis in the relationship of the conventional virtual coaxial speaker device and the listener.

FIG. 23 is an image view showing a case where the sound waves from the woofers are shifted by half-wavelength in the conventional virtual coaxial speaker device.

### BEST MODE FOR CARRYING OUT THE INVENTION

Preferred embodiments of a speaker device having a directivity adjustment panel of the present invention will be described in detail with reference to the accompanied drawings.

### First Embodiment

A first embodiment will be described in detail below using a virtual coaxial speaker device as a preferred embodiment of a speaker device having a directivity adjustment panel of the present invention by way of example.

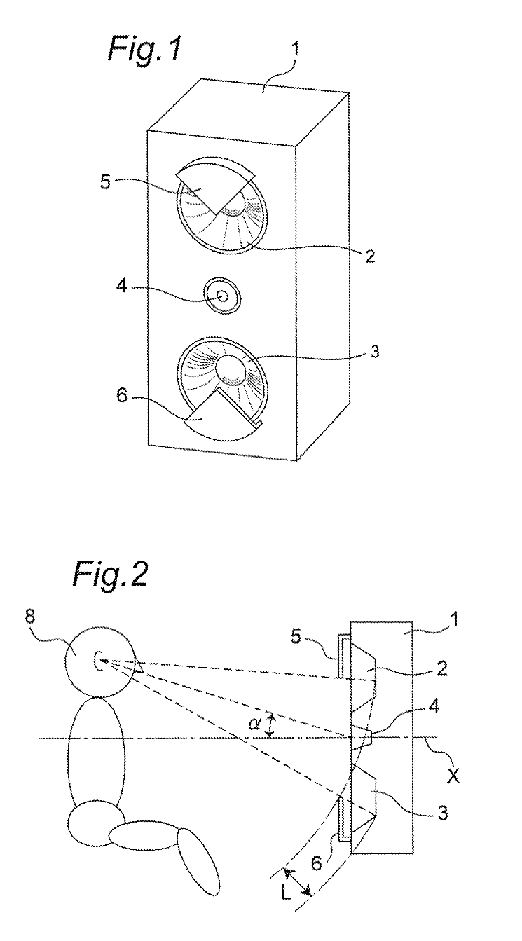

FIG. 1 is a perspective view showing a virtual coaxial speaker device of the first embodiment according to the present invention. FIG. 2 is an explanatory view showing a positional relationship of the virtual coaxial speaker device of the first embodiment and a listener. In FIG. 2, the virtual coaxial speaker device is shown in a side cross-sectional view.

In the virtual coaxial speaker device of the first embodiment, one tweeter 4 is sandwiched by two woofers 2, 3, which are arranged in a line in a speaker box 1 that is a cabinet of solid rectangular body. The speaker box 1 is a bass reflex type speaker box having a thickness of 3 mm, a width of 100 mm, a height of 300 mm, and a depth of 121 mm. The woofers 2, 3 are speaker units for reproducing an audio signal of mid-low sound range, and are cone-shaped speaker units having a diameter of 65 mm. The inter-center distance of the two woofers 2, 3 is 135 mm. The tweeter 4 is a speaker unit for reproducing an audio signal of mid-high sound range, and is a dome-shaped tweeter having a diameter of 19 mm.

As shown in FIG. 1, the virtual coaxial speaker device of the first embodiment includes directivity adjustment panels 5, 6 so as to cover one part of the cone paper i.e., the vibration plates of the woofers 2, 3. The directivity adjustment panels 5, 6 are configured to cover about ¼ of the cone paper of the woofers 2, 3, and are arranged from the most distant opposing edge portions of the two woofers 2, 3 arranged in a line in the longitudinal direction of the speaker box 1 towards the respective center portions of each woofer 2, 3. In other words, as shown in FIG. 1, the directivity adjustment panel 5 of the upper woofer 2 is formed in a fan shape so as to cover one part of the center portion from the upper edge portion of the upper woofer 2. The directivity adjustment panel 6 of the lower woofer 3 is formed in a fan shape so as to cover one part of the center portion from the lower edge portion of the lower woofer 2. The directivity adjustment panels 5, 6 are fan-shaped plates having a thickness of 2 mm and a vertex angle of 90 degrees, the vertex being on the center axis of each woofer 2, 3. In other words, the directivity adjustment panel 5 on the upper side and the directivity adjustment panel 6 on the lower side have the same shape.

In this case, the edge portion of the speaker unit is a position where a supporting member for supporting the periphery of the cone paper that is the vibration plate is arranged, and is the outer circumferential portion of the cone paper.

In FIG. 2, a radiation axis X of the virtual coaxial speaker device of the first embodiment is a center axis passing the center of the tweeter 4. The radiation axis X becomes the virtual radiation axes of the two woofers 2, 3. When a listener 8 listens to a sound at a position deviated from the radiation axis X, a distance difference L between the two woofers 2, 3 shown in FIG. 2 is a distance difference between a distance from the region of the vibration plate not shielded by the directivity adjustment panel 5 of the upper woofer 2 to the listener 8, and a distance from the region of the vibration plate not shielded by the directivity adjustment panel 6 of the lower woofer 3 to the listener 8.

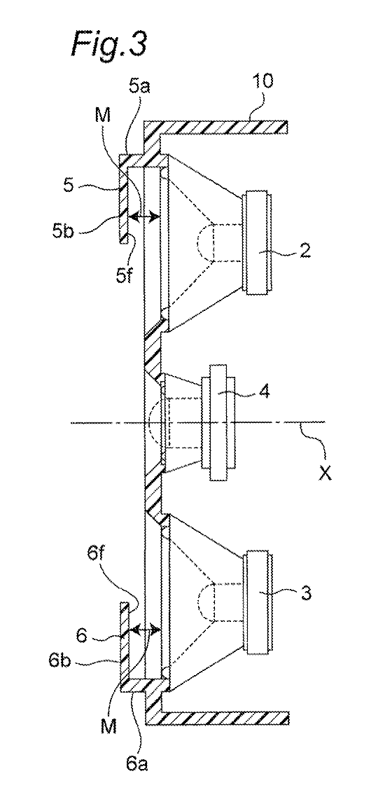

FIG. 3 is a cross-sectional view showing a front baffle unit 10 of the speaker box 1 cut along a center line parallel to the longitudinal direction in the virtual coaxial speaker device according to the first embodiment of the present invention. As shown in FIG. 3, the woofers 2, 3 are fixed on both upper and lower sides of the tweeter 4 at the front baffle unit 10 configuring the front surface of the virtual coaxial speaker device. The directivity adjustment panels 5, 6 are arranged in a projecting manner at the outer surface of the upper and lower portions of the front baffle unit 10. The directivity adjustment panels 5, 6 are integrally molded with the front baffle unit 10 of the speaker box 1, and are made of easily formable resin material.

As shown in the cross-sectional view of FIG. 3, the directivity adjustment panels 5, 6 have an L-shaped cross-section along the longitudinal direction (up and down direction in FIG. 3), and include supporting portions 5a, 6a fixed to the front baffle unit 10, and shielding portions 5b, 6b for covering one part of the cone paper of the woofers 2, 3. The shielding portions 5b, 6b of the directivity adjustment panels 5, 6 are arranged parallel to a plane configured by the edge portions of the woofers 2, 3. As described above, the shielding portions 5b, 6b of the directivity adjustment panels 5, 6 of the first embodiment cover one part of the cone paper of the woofers 2, 3, and a distance M (see FIG. 3) from the inner side surface of the shielding portion 5b, 6b to the front surface of the edge portion of the woofer 2, 3 (inner wall surface of the front baffle unit 10) is set to 5.5 mm.

In the virtual coaxial speaker device of the first embodiment, the distance M from the inner side surface of the shielding portion 5b, 6b to the edge portion of the woofer 2, 3 is set to 5.5 mm, but the distance M is appropriately set according to the characteristics of the speaker device, as described later.

In the virtual coaxial speaker device of the first embodiment, there will be described an example in which a surface (inner wall surface 5f, 6f shown in FIG. 3) facing the cone paper of the woofer 2, 3 of the directivity adjustment panel 5, 6 is formed to a plane orthogonal to the center axis of the woofer 2, 3, but the present invention is not limited to such a configuration. For example, the inner wall surface 5f (reflection surface) of the directivity adjustment panel 5 on the upper side may be obliquely arranged such that the surface on the center axis side becomes closer to the upper woofer 2 than the surface on the edge side. Similarly, the inner wall surface 6f of the directivity adjustment panel 6 on the lower side may be obliquely arranged such that the surface on the center axis side becomes closer to the lower woofer 3 than the surface on the edge side. Thus, in the region covered by the directivity adjustment panels 5, 6 in each cone paper of the woofers 2, 3, the sound wave of the frequency of a specific region of the mid-high sound range generated in the relevant region is reliably shielded by the directivity adjustment panels 5, 6 since the inner wall surfaces 5f, 6f (reflection surfaces) of the directivity adjustment panels 5, 6 are arranged orthogonal to the radiation axis or slightly obliquely so as to be directed towards the supporting portion 5a, 6a side, respectively.

An operation in the virtual coaxial speaker device of the first embodiment configured as above will be described below.

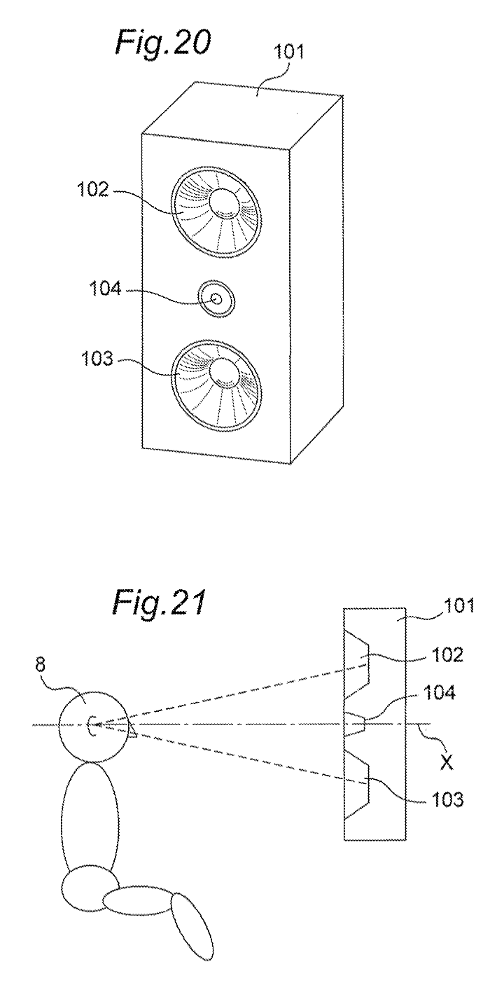

The inventors have conducted an experiment regarding frequency characteristics using a virtual coaxial speaker device having a conventional configuration shown in FIG. 20. The woofers, the tweeter, and the speaker box used in the experiment have the same specification as the woofers 2, 3, the tweeter 4, and the speaker box 1 in the virtual coaxial speaker device of the first embodiment, but the directivity adjustment panels 5, 6 are not arranged.

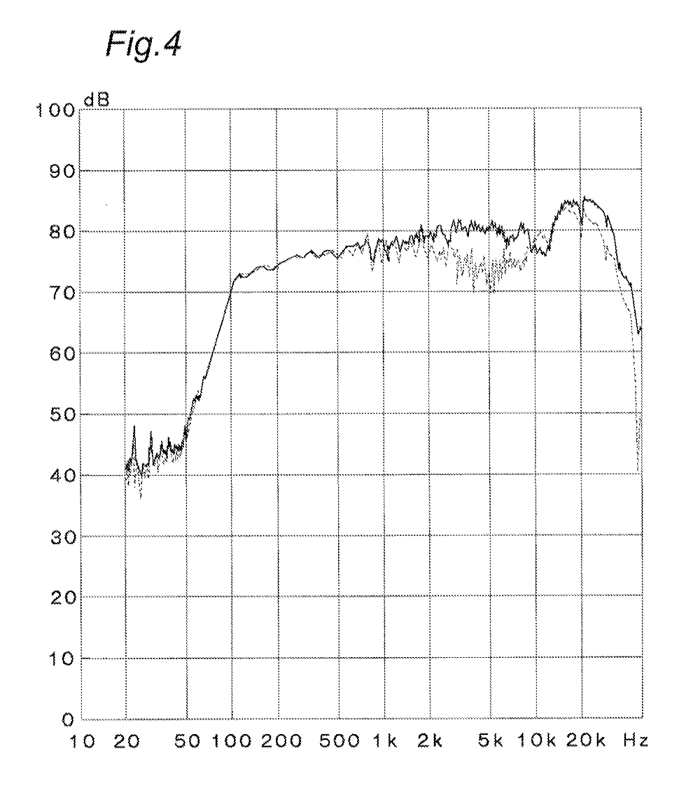

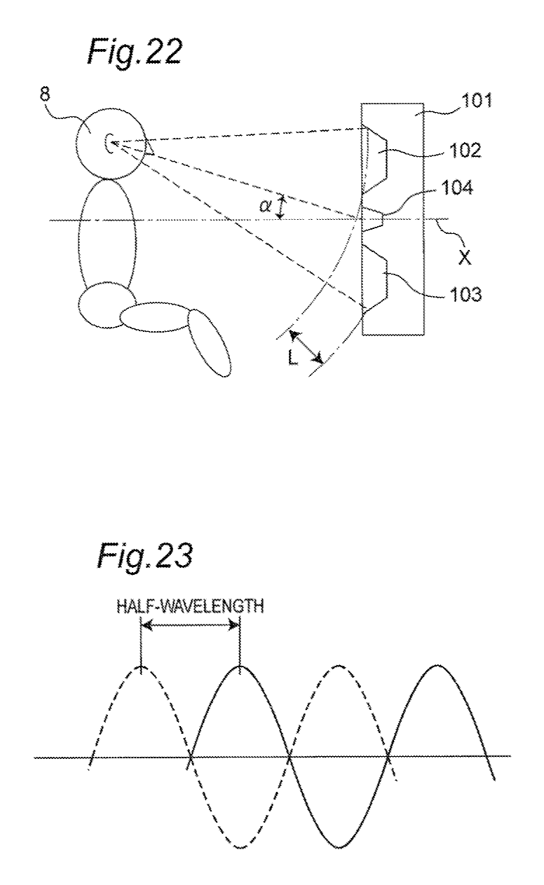

FIG. 4 is a characteristics diagram showing the frequency characteristics in the virtual coaxial speaker device having the conventional configuration. As shown in FIG. 21, a solid line in FIG. 4 shows a measurement result at a position spaced apart by a distance 2 m from a tweeter 104 on a radiation axis X that is the center axis of the tweeter 104. In other words, the solid line shows a case where an angle (angle α in FIG. 22) formed by a line connecting a measurement point and the center of the tweeter 104 and the radiation axis X is 0 degrees. A broken line in FIG. 4 shows the measurement result at the position spaced apart by a distance 2 m from the tweeter 104, where an angle formed by a line connecting the measurement point and the center of the tweeter 104 and the radiation axis X is 15 degrees (angle α is 15 degrees).

As is apparent from FIG. 4, a band where a difference in the characteristics curve of the solid line and the broken line is significant is in a range of between about 2 kHz to 9 kHz, and the directivity at the position deviated from the radiation axis is degraded in such a band.

In the virtual coaxial speaker device having the conventional configuration, the distance difference L (see FIG. 22) between the two woofers needs to be shortened in order to improve the directivity at the position deviated from the radiation axis X of the tweeter. A wavelength at which sound waves from each woofer cancel each other out can be shortened, that is, the frequency can be increased by shortening the distance difference L. If the wavelength at which the sound waves from the woofers cancel each other out can be increased up to greater than or equal to a crossover frequency (e.g., 4 kHz in the above-described virtual coaxial speaker device) at which the sound range from the woofer and the sound range from the tweeter overlap (intersect), the woofer will be in charge up to the crossover frequency region, and the tweeter will be in charge from such a frequency region and higher. If this is possible, the band that attenuates from cancelation of the sound waves from the woofers is reduced, and the virtual coaxial speaker device has a wide directivity and exhibits excellent frequency characteristics.

In the present invention, the directivity adjustment panel is arranged in the speaker device so that the sound waves from the woofers, particularly, the sound waves of the mid-sound range are hard to be canceled out at the position of the listener, and particularly, at the position deviated from the radiation axis.

In the virtual coaxial speaker device of the first embodiment, the directivity adjustment panels 5, 6 are arranged so that the sound wave generated at a portion distant from the tweeter 4 that is one portion of the cone paper, i.e., the vibration plate of the woofer 2, 3 is not directly directed to the listener. By arranging the directivity adjustment panels 5, 6 in this manner, the sound wave of the mid-high sound range component having a strong straight advancement property of the sound waves inhibited by the directivity adjustment panels 5, 6 hits the directivity adjustment panels 5, 6, and then attenuates through diffusion, reflection, and absorption. The sound wave of a low sound range responsible for the sound energy of the entire sound having a weak straight advancement property is radiated while going around the directivity adjustment panels 5, 6, and reaches the listener. Thus, sound energy felt by the listener does not greatly lower.

The inventors have arranged the directivity adjustment panels 5, 6 in a device having the same specification as the conventional virtual coaxial speaker device exhibiting the characteristic curve of FIG. 4, and conducted an experiment related to the frequency characteristics with the relevant device as the virtual coaxial speaker device of the first embodiment.

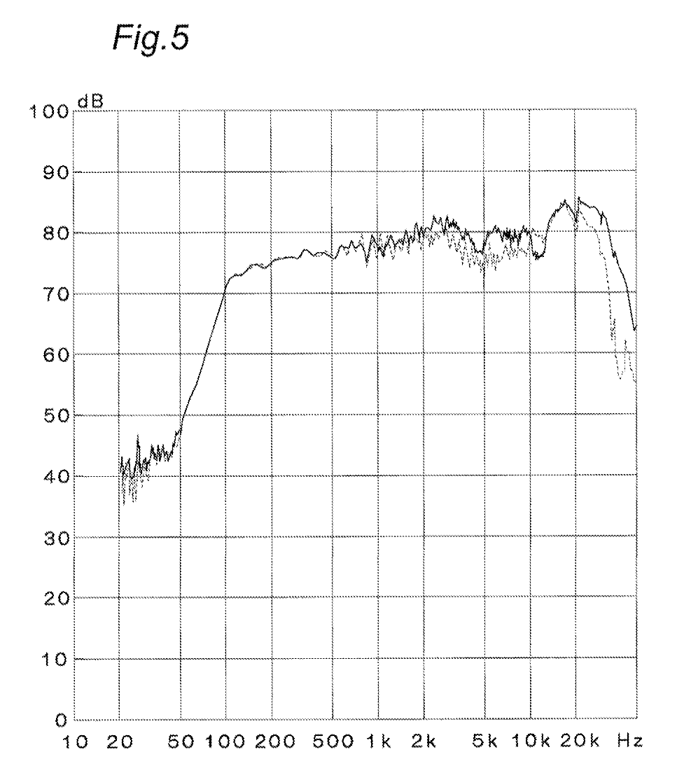

FIG. 5 is a characteristics diagram showing the frequency characteristics in the virtual coaxial speaker device of the first embodiment. The solid line in FIG. 5 shows the measurement result at the position of distance 2 m from the tweeter 4 on the radiation axis X that is the center axis of the vibration plate of the tweeter 4. In other words, the solid line shows a case where the angle (angle α in FIG. 2) formed by a line connecting the measurement point and the center of the tweeter 4 and the radiation axis X is 0 degrees. The broken line in FIG. 5 shows the measurement result at the position spaced apart by a distance of 2 m from the tweeter 4 at the position of an angle of 15 degrees (angle α is 15 degrees) from the radiation axis X with the middle point of the vibration plate of the tweeter 4 as the center, as shown in FIG. 2.

As is apparent from FIG. 5, there is barely any difference in the characteristics curve of the solid line (angle α is 0 degrees) and the broken line (angle α is 15 degrees), and degradation of the directivity at the position deviated from the radiation axis X is greatly improved in the band of between about 2 kHz to 9 kHz, which has been the problem of the conventional virtual coaxial speaker device.

As shown in FIG. 2, the distance difference L between the woofers 2, 3 of the virtual coaxial speaker device of the first embodiment becomes small compared to the conventional virtual coaxial speaker device shown in FIG. 22. Thus, the frequency at which the sound wave from each woofer cancel out becomes high as shown in FIG. 23, and can be raised up to the frequency band of the tweeter 4. As shown in the characteristics curve of FIG. 5, the directivity of the mid-high sound range (2 kHz to 5 kHz) is particularly improved in the virtual coaxial speaker device of the first embodiment having the directivity adjustment panels 5, 6.

In the virtual coaxial speaker device of the first embodiment of the present invention, the directivity adjustment panels 5, 6 are integrally molded with the front baffle unit 10 of the speaker box 1 that is the cabinet, and are arranged to shield one part of the front surface of the woofers 2, 3. The directivity adjustment panels 5, 6 in the first embodiment are arranged at positions 5.5 mm from the inner wall surface of the front baffle unit 10 (edge portions of the woofers 2, 3), and the shielding portions 5b, 6b of the directivity adjustment panels 5, 6 are arranged parallel to the surface configured by the edge portions of the woofers 2, 3. In other words, the shielding portions 5b, 6b are installed parallel to the front surface of the front baffle unit 10. The distance M (see FIG. 3) between the shielding portion 5b, 6b of the directivity adjustment panel 5, 6 and the inner wall surface of the front baffle unit 10 (edge portions of the woofers 2, 3) is determined in view of balance of the sound quality, the directivity, the design, and the like.

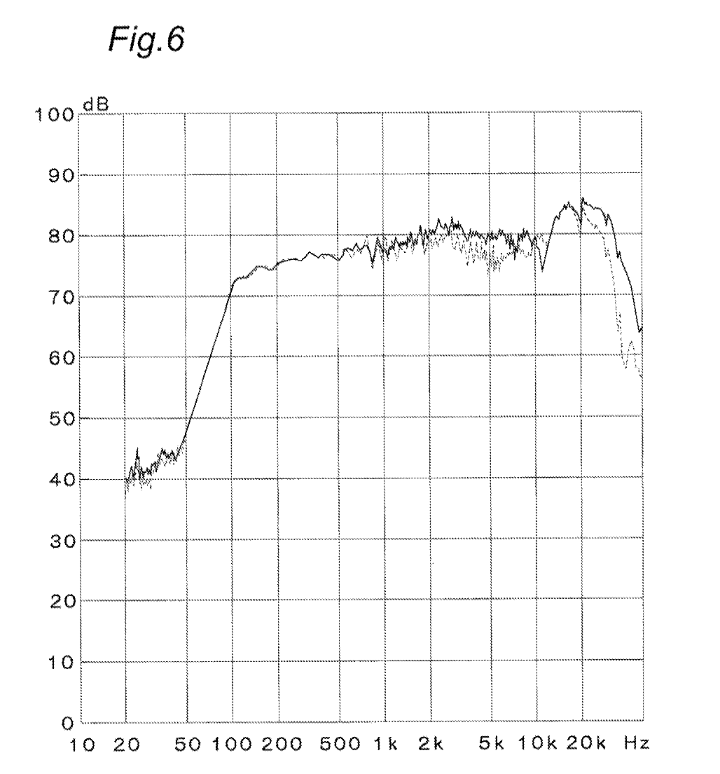

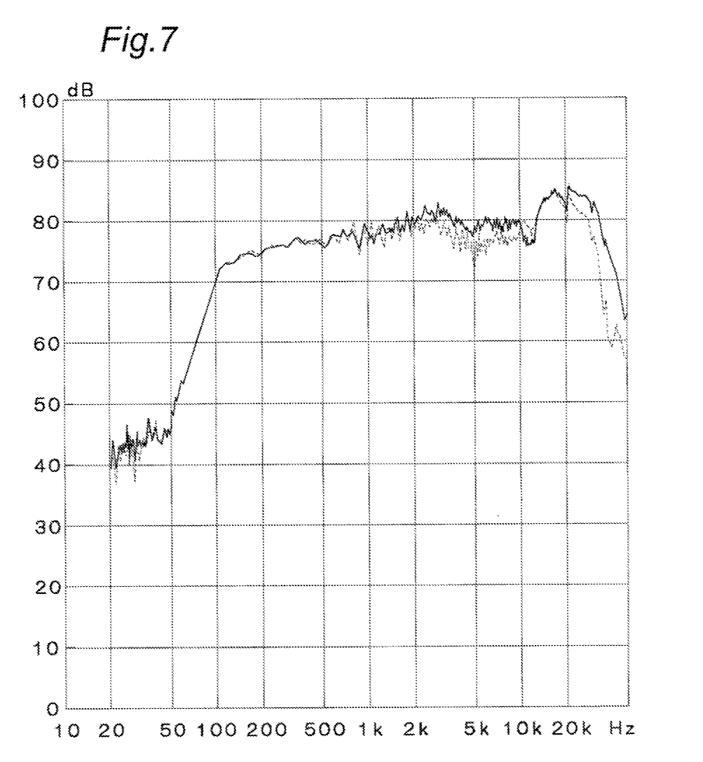

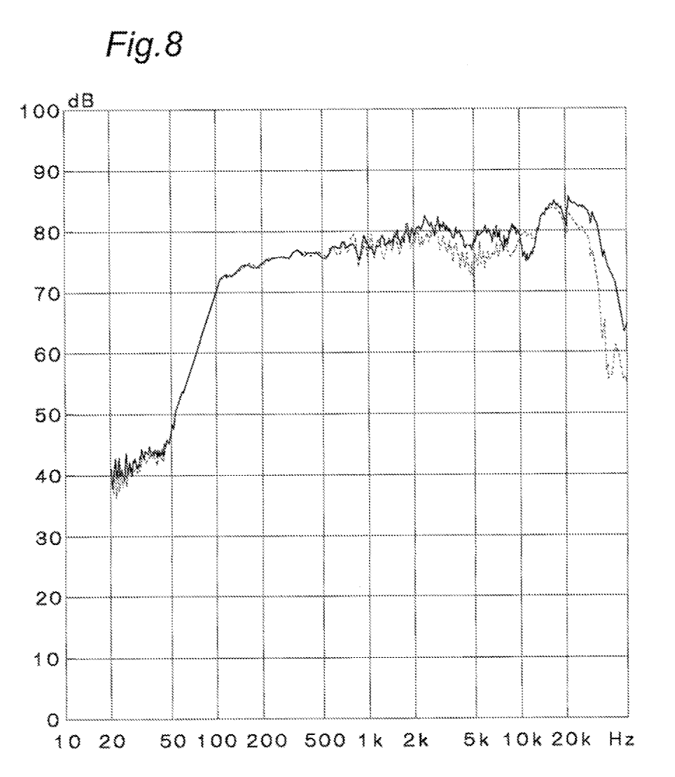

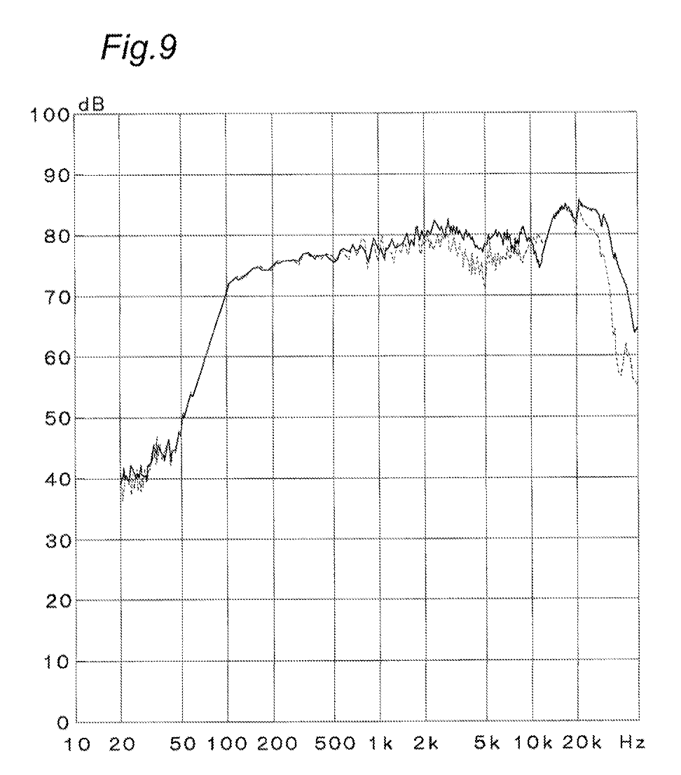

FIGS. 6 to 9 show the frequency characteristics in a case where the distance M of the directivity adjustment panels 5, 6 from the inner wall surface of the front baffle unit 10 is 0 mm, 2.5 mm, 8.5 mm, and 11.5 mm in the virtual coaxial speaker device according to the first embodiment of the present invention.

In FIGS. 6 to 9, the solid line shows the measurement result at the position of distance 2 m from the tweeter 4 on the radiation axis (angle α is 0 degrees) that is the center axis of the vibration plate of the tweeter 4, and the broken line shows the measurement result at the position of distance 2 m from the center of the tweeter 4 at the position of an angle of 15 degrees (angle α is 15 degrees) from the radiation axis X with the middle point of the vibration plate of the tweeter 4 as the center.

As is apparent from the characteristics curves of FIGS. 6 to 9, the directivity, in particular, the directivity of the mid-high range at the position deviated from the radiation axis X can be improved in any case regardless of the distance M by arranging the directivity adjustment panels 5, 6 in the virtual coaxial speaker device. However, in our experiment, a case where the distance M is 5.5 mm, exhibiting the characteristics curve of FIG. 5, obtains preferable frequency characteristics for the virtual coaxial speaker device of the first embodiment of the present invention, and realizes a satisfactory balance in sound quality and directivity. In the case where the distance M is 5.5 mm, the directivity adjustment panels 5, 6 do not contact a speaker net and also excel in design.

The inventors have conducted an experiment for a case where the directivity adjustment panel is not arranged and for a case where the directivity adjustment panel is arranged in the configuration of the virtual coaxial speaker device of the first embodiment.

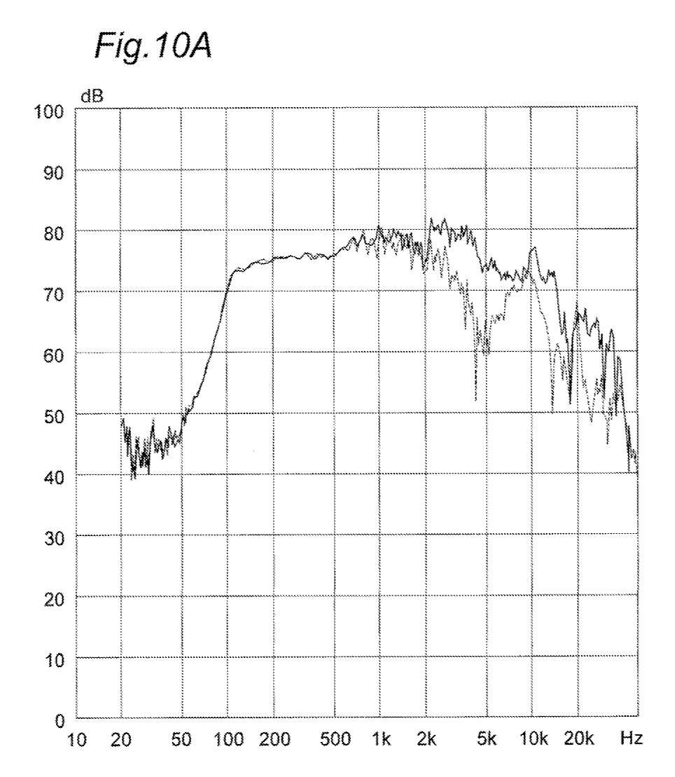

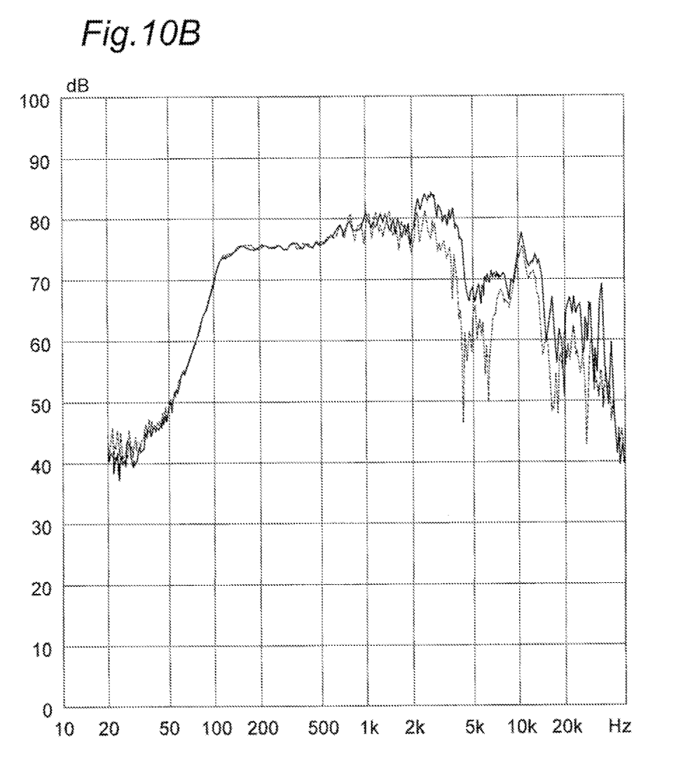

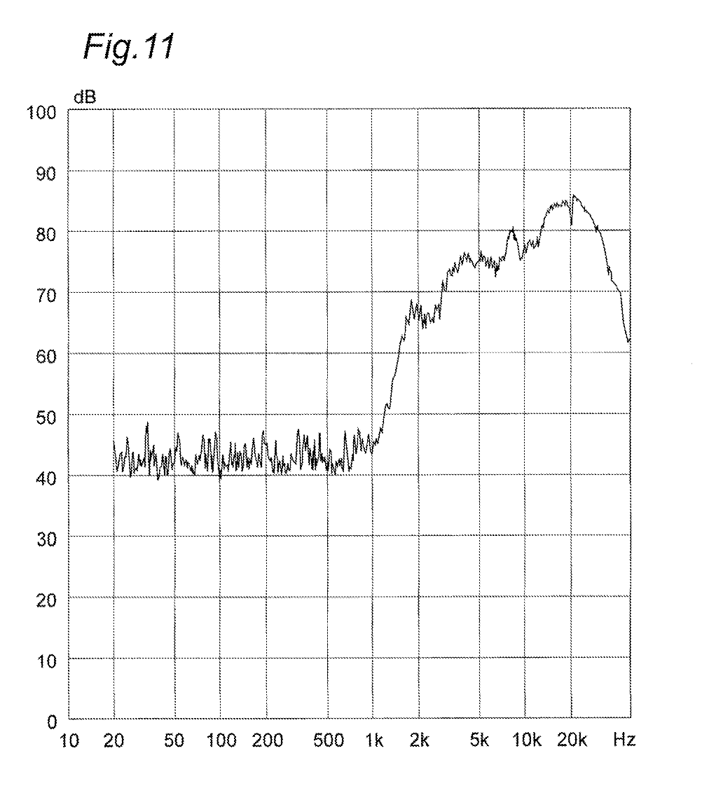

FIG. 10A is a frequency characteristics diagram of the speaker device in which the directivity adjustment panel is not arranged. FIG. 10B is a frequency characteristics diagram of the speaker device in which the directivity adjustment panel is arranged. The frequency characteristics diagrams shown in FIG. 10A and FIG. 10B are measurement results of a case where only the woofer is activated and the tweeter is not activated in the virtual coaxial speaker device. FIG. 11 is a frequency characteristics diagram in a case where only the tweeter is activated in the virtual coaxial speaker device having the directivity adjustment panel. In the frequency characteristics diagrams shown in FIGS. 10A, 10B, and 11, the solid line shows a case where the angle α formed by a line connecting the measurement point and the center of the tweeter 4 and the radiation axis X is 0 degrees, that is, a case where the measurement point is on the radiation axis, and the broken line shows a case where the measurement point is on a vertical line (upper side) intersecting the radiation axis X and the angle α is 15 degrees. The measurement point is a distance of 2 m from the center of the tweeter 4. The specifications of the woofers 2, 3, the tweeter 4, the speaker box 1, and the like used in the measurements are the same as the specifications described in the virtual coaxial speaker device of the first embodiment. The high-cut filter is used in the measurement of the frequency characteristics curve shown in FIGS. 10A and 10B, and the high-pass filter is used in the measurement of the frequency characteristics curve shown in FIG. 11.

Comparing the frequency characteristics curves shown in FIGS. 10A and 10B, the attenuation starts from around the frequency of approximately 1.5 kHz and greatly attenuates from the frequency of 2 kHz in the speaker device in which the directivity adjustment panels 5, 6 are not arranged shown in FIG. 10A when measured at the position where the angle α is 15 degrees (frequency characteristics curve shown with a broken line). In the speaker device in which the directivity adjustment panels 5, 6 are arranged, the attenuation starts from around the frequency of approximately 3 kHz and greatly attenuates from the frequency of 4 kHz.

As is apparent from the above results, the attenuation in the band of a specific frequency (e.g., between 1.5 kHz and 4 kHz) is improved by arranging the directivity adjustment panels 5, 6 at the woofers 2, 3. In the frequency characteristics shown in FIG. 10B, great attenuation is seen at the frequency exceeding 4 kHz, but this does not become a large problem as the relevant frequency band is the frequency band (greater than or equal to 4 kHz) taken charge by the tweeter 4.

FIG. 11 is the frequency characteristics diagram of the virtual coaxial speaker device of a case where only the tweeter is activated. As shown in FIG. 11, when only the tweeter 4 is activated in the virtual coaxial speaker device, the desired sound pressure level is reached substantially at the frequency band of greater than or equal to 2 kHz. Therefore, in the virtual coaxial speaker device of the first embodiment having the directivity adjustment panels 5, 6, excellent directivity is exhibited in the respective frequency bands of the tweeter 4 and the woofers 2, 3, and in particular, great attenuation in the specific frequency band is not found even at the position deviated from the radiation axis X, and improvement of the directivity can be recognized.

Therefore, according to the virtual coaxial speaker device of the first embodiment of the present invention, a high quality speaker device having wide directivity can be provided at low cost by arranging the directivity adjustment panels 5, 6.

In the virtual coaxial speaker device of the first embodiment, the shape of the directivity adjustment panels 5, 6 is a fan shape as shown in FIG. 1, but an excellent effect of a certain extent can be obtained with any shape, such as a semicircular shape, a rectangular shape, or a triangular shape having round vertices, as long as one part of the cone paper of the woofers 2, 3 can be covered.

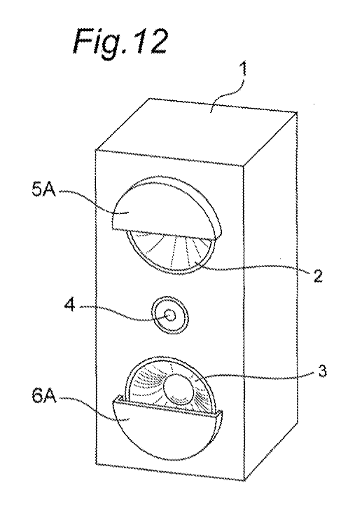

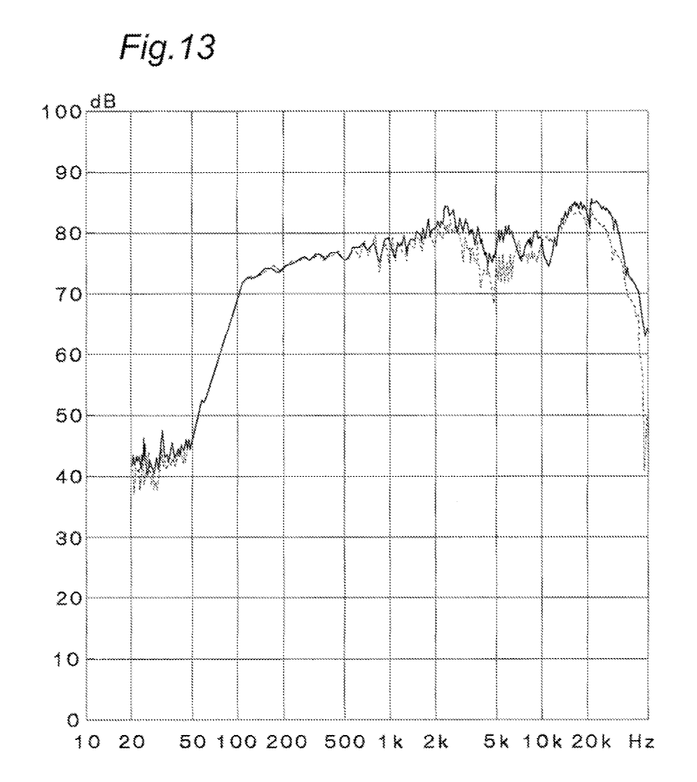

FIG. 12 is a perspective view of a virtual coaxial speaker device in which the shape of the directivity adjustment panels 5A, 6A is a semicircular shape that covers half of the woofers 2, 3. FIG. 13 is a view showing the frequency characteristics of the virtual coaxial speaker device having the semicircular directivity adjustment panels 5A, 6A shown in FIG. 12. The solid line in FIG. 13 shows the measurement result at the position of distance 2 m from the tweeter 4 on the radiation axis X (angle α is 0 degrees) that is the center axis of the vibration plate of the tweeter 4. The broken line in FIG. 13 shows the measurement result at the position of distance 2 m from the tweeter 4 at the position of an angle of 15 degrees (angle α is 15 degrees) from the radiation axis X with the middle point of the vibration plate of the tweeter 4 as the center.

In the virtual coaxial speaker device shown in FIG. 12, the directivity barely has no difference and is satisfactory compared to the virtual coaxial speaker device having the fan-shaped directivity adjustment panels 5, 6 described above, but slight roughness is seen in the characteristics curve shown with the solid line (angle α is 0 degrees) and the broken line (angle α is 15 degrees) with respect to the frequency characteristics.

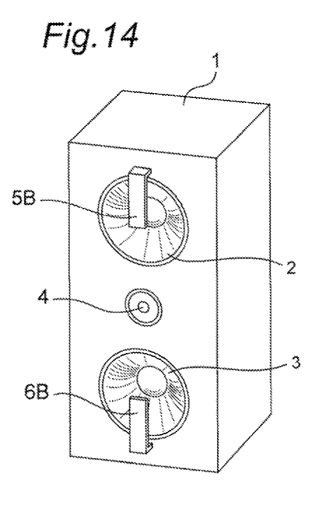

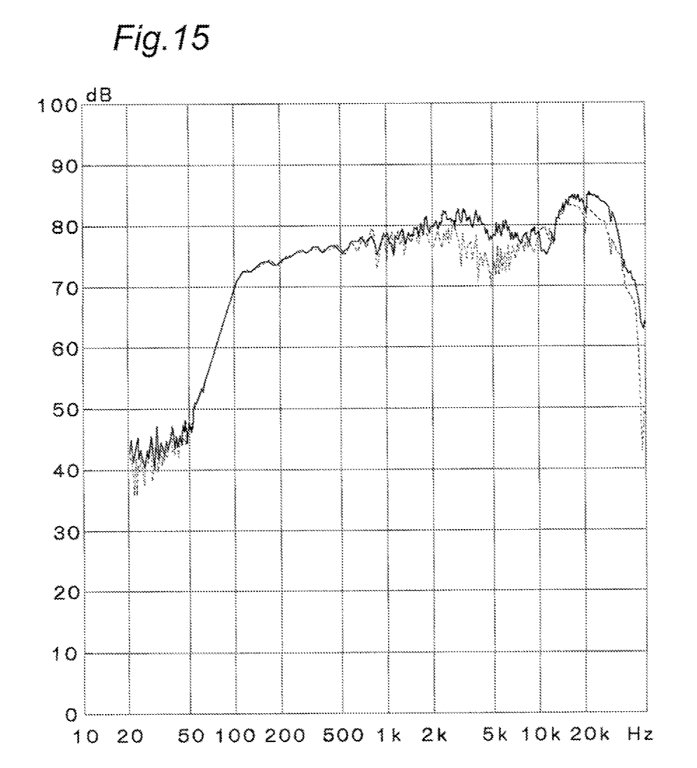

FIG. 14 is a perspective view of the virtual coaxial speaker device in which the shape of the directivity adjustment panels 5B, 6B is a rectangular shape having a width of 2 cm. FIG. 15 is a view showing the frequency characteristics of the virtual coaxial speaker device having the rectangular-shaped directivity adjustment panels 5B, 6B shown in FIG. 14. The solid line in FIG. 15 shows the measurement result at the position of distance 2 m from the tweeter 4 on the radiation axis X (angle α is 0 degrees) that is the center axis of the vibration plate of the tweeter 4. The broken line in FIG. 15 shows the measurement result at the position of distance of 2 m from the tweeter 4 at the position of an angle of 15 degrees (angle α is 15 degrees) from the radiation axis X with the middle point of the vibration plate of the tweeter 4 as the center.

In the virtual coaxial speaker device shown in FIG. 14, the frequency characteristics shown with the solid line (angle α is 0 degrees) and the broken line (angle α is 15 degrees) exhibit characteristics approximate to a flat plane compared to the virtual coaxial speaker device having the fan-shaped directivity adjustment panels 5, 6 described above, but improvement is small in terms of wide directivity and the design is also not preferable.

From the above results, the virtual coaxial speaker device of the first embodiment having the fan-shaped directivity adjustment panels 5, 6 shown in FIG. 1 excels in sound quality (roughness of frequency characteristics) and directivity and is also superior in terms of design compared to the virtual coaxial speaker devices shown in FIGS. 12 and 14. Thus, it can be recognized that the fan-shaped directivity adjustment panels 5, 6 exhibit excellent effects. With respect to the angle of the vertex of the fan shape, the fan shape of 90 degrees exhibit the best result in the first embodiment, but the angle is adjusted according to various conditions such as characteristics of each speaker unit and arrangement of each speaker unit, and hence the vertex angle of the fan shape is preferably in the range of between 60 degrees and 120 degrees.

The virtual coaxial speaker device of the first embodiment has an effect of reducing the die cost since the directivity adjustment panels 5, 6 can be integrally formed with the front baffle plate.

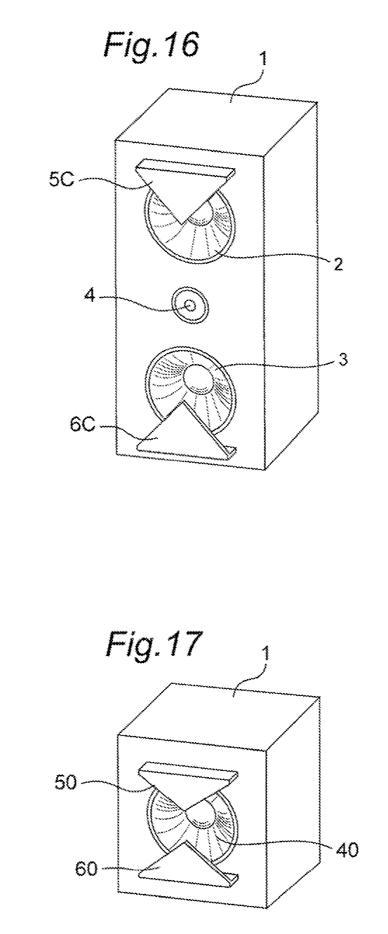

In the virtual coaxial speaker device of the first embodiment shown in FIG. 1, there has been described an example in which the directivity adjustment panels 5, 6 are integrally molded with the front baffle unit 10 of the speaker box 1, but the directivity adjustment panels may be formed as separate members from the front baffle unit 10 and then coupled to the speaker box 1. FIG. 16 is a perspective view showing a virtual coaxial speaker device in which the directivity adjustment panels 5C, 6C are formed as separate members from the speaker box 1, and the directivity adjustment panels 5C, 6C are attached to the front baffle unit of the speaker box 1. Similar effects are obtained for the directivity as the virtual coaxial speaker device of the first embodiment in the virtual coaxial speaker device configured as above.

If the directivity adjustment panel is configured to be removably attachable to the speaker box 1, the directivity adjustment panel having different shape and configuration can be attached according to the characteristics of the virtual coaxial speaker device, and adjustment according to the preference of the listener can be made.

Furthermore, the directivity adjustment panel may be configured to be attachable to a desired position with respect to the speaker box 1. In other words, attachment means of the directivity adjustment panel may be arranged at a predetermined position of the speaker box 1 in advance so that the region to shield the woofer by the directivity adjustment panel can be changed according to the preference of the listener or the position of the listener.

In the virtual coaxial speaker device of the first embodiment, an example in which the directivity adjustment panels 5, 6 are made of the same resin material as the speaker box 1 has been described, but the directivity adjustment panel may be made from a material having a sound absorbing effect. For example, the directivity adjustment panel may be formed using glass fiber, felt, wood, and the like. Moreover, irregularities may be formed on the surface facing the speaker unit of the directivity adjustment panel to diffusely reflect one part of the sound wave radiated from the speaker unit.

In the first embodiment, description has been made assuming that the virtual coaxial speaker device is vertically arranged (speaker unit is arranged in a vertical direction), but normally, the virtual coaxial speaker device may be horizontally arranged (speaker unit is arranged in a horizontal direction), where improvement can be made to realize wide directivity with respect to the horizontal direction if the virtual coaxial speaker device of the first embodiment is horizontally arranged.

The virtual coaxial speaker device of the first embodiment according to the present invention can be applied to a speaker of various types of acoustic systems such as a 5.1 ch surround system and a 7.1 surround system, and can be horizontally arranged or vertically arranged since excellent directivity is realized. Thus, the virtual coaxial speaker device of the first embodiment according to the present invention has a greater degree of freedom of installment and can be applied to various types of acoustic devices.

Therefore, the speaker device of the first embodiment provides a high quality acoustic device having wide directivity and exhibiting excellent frequency characteristics at low cost by arranging the directivity adjustment panels 5, 6.

### Second Embodiment

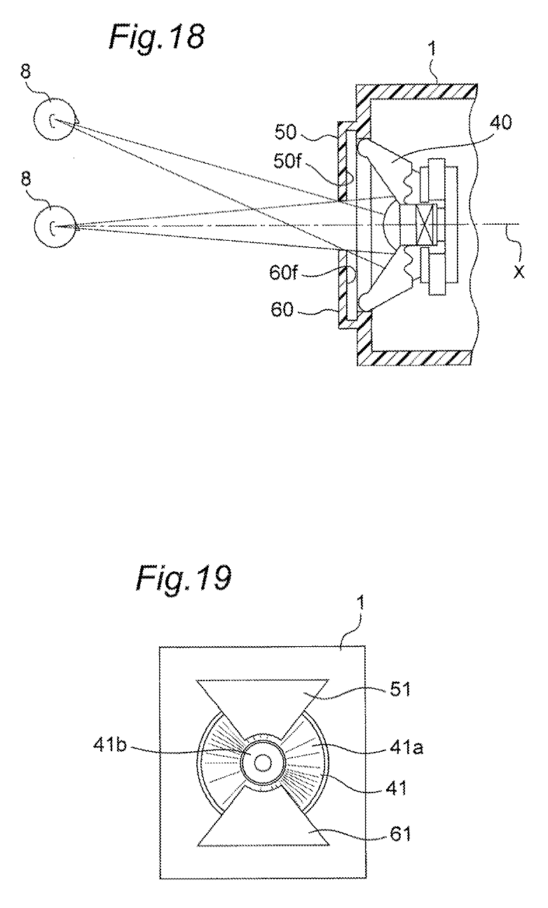

A second embodiment will be described in detail below using a speaker device including a full range speaker unit as a preferred embodiment of the speaker device having the directivity adjustment panels of the present invention by way of example. FIG. 17 is a perspective view showing the speaker device including a full range speaker unit 40 according to the second embodiment of the present invention. FIG. 18 is a cross-sectional view showing the vicinity of the front baffle unit of the speaker device of the second embodiment.

As shown in FIG. 17, the speaker box 1 including the full range speaker unit 40 includes directivity adjustment panels 50, 60. The directivity adjustment panels 50, 60 in the speaker device of the second embodiment have functions similar to the directivity adjustment panels 5, 6 in the virtual coaxial speaker device of the first embodiment.

The directivity adjustment panels 50, 60 in the speaker device of the second embodiment are arranged to cover one part of the upper and lower portions of the cone paper that is the vibration plate of the full range speaker unit 40. As shown in FIG. 17, the directivity adjustment panel 50 on the upper side has a fan shape having a vertex angle of 90 degrees so as to cover about ¼ of the entire cone paper of the full range speaker unit 40 and about ½ of the upper half of the cone paper. Similarly, the directivity adjustment panel 60 on the lower side has a fan shape having a vertex angle of 90 degrees so as to cover about ¼ of the entire cone paper of the full range speaker unit 40 and about ½ of the lower half of the cone paper. Each vertex of the fan-shaped directivity adjustment panel 50, 60 is arranged near the center portion of the cone paper of the full range speaker unit 40.

As described above, the entire cone paper that is the vibration plate reciprocates and vibrates up to the frequency of low sound range of about 1 kHz, but divided vibration occurs on the cone paper from just when the frequency exceeds the low sound range. If the listener listens to the sound of the speaker unit in which such divided vibration occurred at the position deviated from the radiation axis of the speaker unit, and in particular, if the sound from a plurality of vibration regions that occurred at the outer peripheral portion of the cone paper reaches the listener, the sounds shifted by half-wavelength cancel each other out, and the sound pressure level of the relevant sound greatly attenuates. The frequency at which such a phenomenon occurs differs depending on the diameter of the speaker unit and the position where the listener is listening, but if a such phenomenon appears in the mid-sound range, in particular, the sound may lack the mid-sound range and the listener may feel a sense of discomfort.

To resolve such a problem, in the speaker device of the second embodiment, a specific region of the sound wave of the frequency of the mid-sound range that occurred in the upper and lower regions of the cone paper of the full range speaker unit 40 is shielded by the fan-shaped directivity adjustment panels 50, 60 as shown in FIGS. 17 and 18, so that the desired frequency characteristics are obtained even when the listener listens at the position deviated in the up and down direction from the radiation axis.

The surface (inner wall surfaces 50f, 60f) facing the cone paper of the directivity adjustment panels 50, 60 is arranged to be at least orthogonal to the radiation axis X (see FIG. 18) that is the center axis of the full range speaker unit 40, or such that the center axis side becomes closer to the full range speaker unit 40 than the edge side. Since the inner wall surfaces 50f, 60f of the directivity adjustment panels 50, 60 are arranged in this manner, in the region covered by the directivity adjustment panels 50 60 in the cone paper of the full range speaker unit 40, the sound wave of the frequency of the mid-sound range generated in the relevant region is shielded by the directivity adjustment panels 50, 60. Therefore, cancelation of the sound of the mid-sound range from the full range speaker unit 40 is reduced and the audio in which the attenuation of the sound of the mid-sound range is small can be listened even when the listener 8 listens at the position deviated in the up and down direction from the radiation axis. The sound of the frequency of the low sound range goes around to the directivity adjustment panels 50, 60, and thus does not greatly attenuate as the sound pressure.

In the speaker device of the second embodiment, the directivity adjustment panels 50, 60 are configured to shield one part of the sound wave of the frequency of the mid-sound range generated in the upper and lower regions of the cone paper. Normally, the speaker device is installed facing the listener 8, and the angle in a left and right direction of the radiation axis of the speaker device is adjusted according to the preference of the listener 8. The adjustment in the left and right direction of the speaker device is easily made by the listener 8. The up and down direction of the speaker device differs depending on the height of the chair the listener 8 sits on, the sitting height of the listener 8, the height of the speaker stand, and the like, where the adjustment in the up and down direction is not easily made compared to the adjustment in the left and right direction. In particular, since aligning the axis of directivity in the up and down direction is difficult, the speaker device of the second embodiment is configured to exhibit wide directivity by shielding one part of the sound wave of the frequency of the mid-sound range generated in the upper and lower regions of the cone paper with the directivity adjustment panels 50, 60.

Therefore, the speaker device of the second embodiment provides a high quality acoustic device having wide directivity and exhibiting excellent frequency characteristics at low cost by arranging the directivity adjustment panels 50, 60.

In the speaker device of the second embodiment, an example in which the fan-shaped directivity adjustment panels 50, 60 are arranged has been described, but the present invention is not limited to such a shape, and the directivity adjustment panels may be deformed according to the characteristics of the full range speaker unit. For example, the vertex angle of the fan shape may be within a range of between 60 degrees and 120 degrees, as described in the first embodiment. The present invention also encompasses deformation to various shapes such as semicircle and rectangle as shown in FIGS. 12 and 14. Furthermore, in the speaker device of the second embodiment, the directivity adjustment panels 50, 60 may be configured removably attachable to the speaker box or may be integrally configured with the speaker box, as shown in FIG. 16.

### Third Embodiment

A third embodiment will be described in detail below using a speaker device including a two-way coaxial speaker unit of a woofer and a tweeter as a preferred embodiment of the speaker device having the directivity adjustment panels of the present invention by way of example. FIG. 19 is a front view showing the speaker device including a coaxial speaker unit 41 according to the third embodiment of the present invention.

As shown in FIG. 19, the speaker box 1 of the speaker device of the third embodiment includes the coaxial speaker unit 41 with a woofer 41a, and a tweeter 41b arranged at a center pole at the center portion of the woofer 41a. Similar to the first and second embodiments, the speaker box 1 including the coaxial speaker unit 41 includes directivity adjustment panels 51, 61. The directivity adjustment panels 51, 61 of the speaker device of the third embodiment have functions similar to the directivity adjustment panels 5, 6, 50, 60 of the first and second embodiments described above.

The directivity adjustment panels 51, 61 in the speaker device of the third embodiment are arranged to cover one part of the upper and lower portions of the cone paper that is the vibration plate of the woofer 41a of the coaxial speaker unit 41. As shown in FIG. 19, the directivity adjustment panel 51 on the upper side has a substantially fan shape so as to cover about ¼ of the entire cone paper of the woofer 41a and about ½ of the upper half of the cone paper. Similarly, the directivity adjustment panel 61 on the lower side has a substantially fan shape so as to cover about ¼ of the entire cone paper of the woofer 41a and about ½ of the lower half of the cone paper. Each vertex portion of the directivity adjustment panel 51, 61 is cut to a curved shape so as not to cover the tweeter 41b. In other words, the directivity adjustment panel 51 on the upper side and the directivity adjustment panel 61 on the lower side have the same shape.

Similar to the speaker devices of the first and second embodiments, in the speaker device of the third embodiment configured as above, the specific region of the sound wave of the frequency of the mid-sound range generated in the upper and lower regions of the cone paper of the woofer 41a is shielded by the fan-shaped directivity adjustment panels 51, 61, so that cancelation of the sound of the mid-sound range from the woofer 41a is reduced and the audio in which the attenuation of the sound of the mid-sound range is small can be listened even when the listener listens at the position deviated in the up and down direction from the radiation axis.

Therefore, the speaker device of the third embodiment provides a high quality acoustic device having wide directivity and exhibiting excellent frequency characteristics at low cost by arranging the directivity adjustment panels 51, 61.

In the speaker device of the third embodiment, the vertex portion of the fan-shaped directivity adjustment panels 51, 61 is cut to a curved shape to correspond to the position of the tweeter 41b, but the present invention is not limited to such a shape, and the directivity adjustment panels 51, 61 may be deformed according to the characteristics of the coaxial speaker unit. For example, the vertex angle of the fan shape may be in a range of between 60 degrees and 120 degrees to form a smaller fan shape, as described in the first embodiment. The present invention also encompasses deformation to various shapes such as semicircle and rectangle as shown in FIGS. 12 and 14. Furthermore, in the speaker device of the third embodiment, the directivity adjustment panels 51, 61 may be removably attachable to the speaker box or may be integrally configured with the speaker box, as shown in FIG. 16.

The invention has been described with preferred embodiments in detail to a certain extent, but the currently disclosed contents of the preferred embodiments may be changed at subtle points of the configuration, where change in combination and order of each element can be implemented without deviating from the scope and the idea of the claimed invention.

### INDUSTRIAL APPLICABILITY

The speaker device of the present invention provides a high quality speaker device having wide directivity and exhibiting excellent frequency characteristics with a simple configuration and at low cost, and is a highly versatile device capable of being applied to various types of acoustic devices.

1. A speaker device comprising:
a speaker unit including a vibration plate that becomes a sound source;
a cabinet attached with the speaker unit; and
a directivity adjustment panel arranged with a predetermined distance from an edge portion of an outer periphery of the vibration plate of the speaker unit to cover one portion in a vibration region of the vibration plate of the speaker unit; wherein
the directivity adjustment panel is configured to reflect a sound wave received from the vibration plate toward the vibration plate.

2. The speaker device according to claim 1, wherein the directivity adjustment panel includes a reflection surface parallel to a plane configured by the edge portion of the outer periphery of the vibration plate, the reflection surface including a shielding portion arranged to face the vibration plate and a supporting portion for fixing the shielding portion to the cabinet.

3. The speaker device according to claim 1, wherein the directivity adjustment panel includes a reflection surface in which a position facing a center side of the vibration plate is arranged closer to the vibration plate than a position facing the edge portion side, the reflection surface including a shielding portion arranged to face the vibration plate and a supporting portion for fixing the shielding portion to the cabinet.

4. The speaker device according to claim 2, wherein the shielding portion has a fan shape in which a portion facing the edge portion of the vibration plate is formed large and a portion facing the center side of the vibration plate is formed small.

5. The speaker device according to claim 2, wherein the shielding portion has a fan shape in which a portion facing the edge portion of the vibration plate is large and a portion facing the center side of the vibration plate is a vertex, a vertex angle of the fan shape being within a range of between 60 degrees and 120 degrees.

6. The speaker device according to claim 2, wherein the shielding portion is arranged to cover upper and lower portions of the vibration region of the vibration plate.

7. The speaker device according to claim 2, being a virtual coaxial speaker device in which the speaker unit is configured by sandwiching one tweeter with two woofers, the directivity adjustment panel being arranged on the two woofers.

8. The speaker device according to claim 2, being a coaxial speaker device in which the speaker unit has a tweeter and a woofer coaxially arranged, the directivity adjustment panel being arranged on the woofer.

9. The speaker device according to claim 2, being a speaker device in which the speaker unit is a full range speaker unit, the shielding portion being arranged to cover upper and lower portions of the vibration region of the vibration plate.

10. The speaker device according to claim 2, wherein the directivity adjustment panel is integrally molded with the cabinet.

11. The speaker device according to claim 2, wherein the directivity adjustment panel is configured to be removably attachable with respect to the cabinet.

12. A virtual coaxial speaker device in which two woofers are installed on a baffle plate of a cabinet, wherein
a directivity adjustment panel is arranged to cover one part of each of the two woofers; and
the directivity adjustment panel is formed facing an edge portion on both sides spaced apart from a virtual radiation axis of a vibration plate of the two woofers, and is configured so that a shielding region becomes smaller from an edge portion towards a center portion to cover one part of the woofer.

13. The speaker device according to claim 12, wherein the directivity adjustment panel is integrally formed with the cabinet.

14. The speaker device according to claim 12, wherein the directivity adjustment panel is arranged with a predetermined distance from the edge portion of the vibration plate.

15. The speaker device according to claim 3, wherein the shielding portion has a fan shape in which a portion facing the edge portion of the vibration plate is formed large and a portion facing the center side of the vibration plate is formed small.

16. The speaker device according to claim 3, wherein the shielding portion has a fan shape in which a portion facing the edge portion of the vibration plate is large and a portion facing the center side of the vibration plate is a vertex, a vertex angle of the fan shape being within a range of between 60 degrees and 120 degrees.

17. The speaker device according to claim 3, wherein the shielding portion is arranged to cover upper and lower portions of the vibration region of the vibration plate.

18. The speaker device according to claim 3, being a virtual coaxial speaker device in which the speaker unit is configured by sandwiching one tweeter with two woofers, the directivity adjustment panel being arranged on the two woofers.

19. The speaker device according to claim 3, being a coaxial speaker device in which the speaker unit has a tweeter and a woofer coaxially arranged, the directivity adjustment panel being arranged on the woofer.

20. The speaker device according to claim 3, being a speaker device in which the speaker unit is a full range speaker unit, the shielding portion being arranged to cover upper and lower portions of the vibration region of the vibration plate.

21. The speaker device according to claim 3, wherein the directivity adjustment panel is integrally molded with the cabinet.

22. The speaker device according to claim 3, wherein the directivity adjustment panel is configured to be removably attachable with respect to the cabinet.

23. The speaker device according to claim 13, wherein the directivity adjustment panel is arranged with a predetermined distance from the edge portion of the vibration plate.
